(19) United States
(12) Patent Application Publication
(10) Pub. No.: US 2021/0270232 A1
(43) Pub. Date: Sep. 2, 2021

(54) WIND POWER PLANT ROTOR BLADE

(71) Applicant: WOBBEN PROPERTIES GMBH, Aurich (DE)

(72) Inventor: Alexander HOFFMANN, Emden (DE)

(73) Assignee: Wobben Properties GmbH, Aurich (DE)

(21) Appl. No.: 17/055,078

(22) PCT Filed: May 23, 2019
(86) PCT No.: PCT/EP2019/063368

§ 371 Date: Nov. 12, 2020

(30) Foreign Application Priority Data
May 29, 2018 (DE) 10 2018 112 833.9

(51) Int. Cl. F03D 1/06

(52) U.S. Cl. CPC F03D 1/0675; F05B 2240/304; F05B 2240/302

(57) ABSTRACT

Provided is a wind power plant rotor blade, with a rotor blade root area, a rotor blade tip area, a rotor blade leading edge, a rotor blade trailing edge, a rotor blade longitudinal axis, a rotor blade inner section, a rotor blade outer section, as well as a dividing plane between the rotor blade outer section and the rotor blade inner section. The rotor blade can be split along the dividing plane. The rotor blade further has a respective reinforcement area in the rotor blade inner section and the rotor blade outer section, which each are arranged next to the dividing plane. The rotor blade is given a multi-part design by splitting it along the dividing plane. After splitting the rotor blade along the dividing plane, the reinforcement area on the rotor blade inner section can be fastened to the reinforcement area of the rotor blade outer section.

### BACKGROUND

### Technical Field

The present invention relates to a wind power plant rotor blade, as well as to a wind power plant.

### Description of the Related Art

Due to the increasing size of modern wind power plants, the rotor blades of the wind power plants also became longer and longer, leading in part to significant transport problems. In order to reduce transport problems, the rotor blades are increasingly being split apart along their longitudinal axis, transported separately to the construction site, and only assembled once there. However, the disadvantage to such split rotor blades is that they are heavier and more cost-intensive than unsplit rotor blades.

The German Patent and Trademark Office searched the following documents in the priority-establishing German patent application: DE 10 2010 046 519 A1, DE 10 2011 088 025 A1, DE 10 2014 206 670 A1, DE 10 2014 220 249 A1 and EP 2 815 861 A1.

### BRIEF SUMMARY

Provided is a wind power plant rotor blade that enables an improved transportability when needed.

Therefore provided is a wind power plant rotor blade with a rotor blade root area, a rotor blade tip area, a rotor blade leading edge, a rotor blade trailing edge, a rotor blade longitudinal axis, a rotor blade inner section, a rotor blade outer section, as well as a dividing plane between the rotor blade outer section and the rotor blade inner section. The rotor blade can be split along the dividing plane. The rotor blade further has a respective reinforcement area in the rotor blade inner section and the rotor blade outer section, which each are arranged next to the dividing plane. The rotor blade is given a multi-part design by splitting it along the dividing plane. After splitting the rotor blade along the dividing plane, the reinforcement area on the rotor blade inner section can be fastened to the reinforcement area of the rotor blade outer section.

In one aspect of the present invention, the wind power plant rotor blade has a first main belt in the rotor blade inner section and a second main belt in the rotor blade outer section.

In another aspect of the present invention, the ends of the first and second main belts are scarfed in design.

In another aspect of the present invention, the rotor blade has a first web in the area of the first main belt, and a second web in the area of the second main belt. The first and second webs end before the dividing plane.

In another aspect of the present invention, the rotor blade has a trailing edge reinforcement and a trailing edge web both in the rotor blade inner section and in the rotor blade outer section.

In another aspect of the present invention, the reinforcement areas in the rotor blade inner section and the rotor blade outer section have a plurality of through holes or through bores.

Provided is a wind power plant with at least one wind power plant rotor blade described above.

Provided is a method for mounting a wind power plant rotor blade to a nacelle of a wind power plant. This is done by checking logistical restrictions on the installation site of the wind power plant. Based on the logistical restrictions, a one-part or multi-part rotor blade is selected. A one-part rotor blade is manufactured in a main die. Alternatively thereto, a multi-part rotor blade is manufactured in the main die based on the logistical restrictions. The wind power plant rotor blade manufactured in one part is split along the dividing plane, so as to obtain a rotor blade inner section and a rotor blade outer section. The rotor blade inner section and rotor blade outer section are transported to the installation site separately from each other. The rotor blade inner section and rotor blade outer section are joined together at the installation site. The assembled rotor blade is mounted on the nacelle of the wind power plant.

Depending on the location of the installation site of a wind power plant, it can happen that a one-part rotor blade cannot be easily transported to the installation site. For example, this may be rooted in the fact that the access route to the installation site does not permit transporting a very long rotor blade. Furthermore, it may be that the costs of transporting the rotor blades to the installation site are extremely high, for example because trees have to be cut down or a special access route must be provided. In cases like these, it would make sense not to transport the rotor blade to the installation site in one part, but rather to give the rotor blade a multi-part configuration. However, a multi-part configuration for a rotor blade typically requires that an alternative main die be provided, since the respective parts of the rotor blade are typically manufactured separately. But providing alternative main dies is very cost-intensive.

Therefore, it is proposed that one main die be used, and that a decision then be made depending on the installation site as to whether the rotor blades must have a one-part or multi-part configuration. If they can have a one-part configuration, nothing need be changed about rotor blade fabrication. However, if they are to have a multi-part (for example, two-part) configuration, the respective main die can be used, but measures must also be taken to then split, for example saw open, the rotor blade along a dividing plane, and then put it back together again at the construction site. To this end, provided is a reinforcement area in the rotor blade inner section and in the rotor blade outer section, wherein the respective reinforcement areas are adjacent to the dividing plane along which the rotor blade initially manufactured as one part is then split or sawed open.

Therefore it is significantly more cost effective to manufacture a multi-part rotor blade.

Provided is a wind power plant rotor blade that can be used both as a one-part rotor blade and as a multi-part rotor blade. In particular, the same component shapes are to be used for both variants. Should a multi-part rotor blade be required, it can be achieved by splitting the rotor blade manufactured as one part. The wind power plant rotor blade has structural reinforcements in the area of the possible dividing plane.

The rotor blade is typically produced in two halves or half shells, and the half shells are then bonded together. The wind power plant rotor blade has structural reinforcements in the area of the possible dividing plane, in particular with through holes or bores on each part of the rotor blade, so that the two rotor blade parts (rotor blade inner part, rotor blade outer part) can be fastened to each other at the construction site.

The dividing plane preferably lies in the area of the rotor blade that is accessible to service employees, so that the connection between the two parts of the rotor blades can be checked.

A main die can be used for a rotor blade designed as one part or subsequently as multiple parts. The exterior shape of the one-part rotor blade as well as of the multi-part rotor blade are thus identical. If a multi-part rotor blade is to be constructed, the main die is used to manufacture the two half shells of the rotor blade. In addition thereto, other elements are implemented in the two hard shells, which make it possible to split the rotor blade along the dividing plane, transport it separately to the installation site, and then put the rotor blade back together at the installation site.

In one aspect of the present invention, the rotor blade can be given a multi-part configuration by manufacturing one rotor blade as one part and then splitting it along a dividing plane, thereby resulting in a rotor blade inner section and a rotor blade outer section.

A main belt can be provided in both the rotor blade inner section and in the rotor blade outer section. In one aspect of the present invention, no continuous main belt is thus provided. The two (partial) main belts can optionally be connected with each other in the rotor blade inner section and the rotor blade outer section.

Additional exemplary embodiments are the subject of the subclaims.

### BRIEF DESCRIPTION OF THE SEVERAL VIEWS OF THE DRAWINGS

Advantages and exemplary embodiments of the invention will be explained in more detail below with reference to the drawings.

FIG. 1 shows a schematic illustration of a wind power plant according to the invention,

FIG. 2 shows a schematic illustration of a wind power plant rotor blade according to a first exemplary embodiment,

FIG. 3 shows a schematic illustration of a wind power plant rotor blade according to a second exemplary embodiment,

FIG. 4 shows a schematic illustration of a wind power plant rotor blade according to a third exemplary embodiment,

FIG. 5 shows a schematic illustration of a wind power plant rotor blade according to a fourth exemplary embodiment,

FIG. 6 shows a schematic illustration of a wind power plant rotor blade according to a fifth exemplary embodiment,

FIG. 7 shows a schematic illustration of a wind power plant rotor blade according to a sixth exemplary embodiment,

FIG. 8 shows a perspective view of trailing edge webs according to the seventh exemplary embodiment.

### DETAILED DESCRIPTION

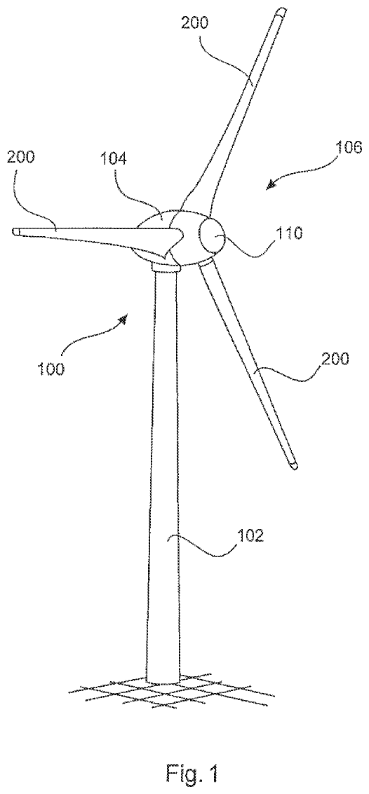

FIG. 1 shows a schematic illustration of a wind power plant according to the invention. The wind power plant 100 has a tower 102 as well as a nacelle 104 and an aerodynamic rotor 106. The aerodynamic rotor 106 has a spinner 110, and also three rotor blades 200, for example. The aerodynamic rotor 106 is directly or indirectly coupled with the electrical generator, and drives an electrical rotor of the generator, so as to generate electrical energy.

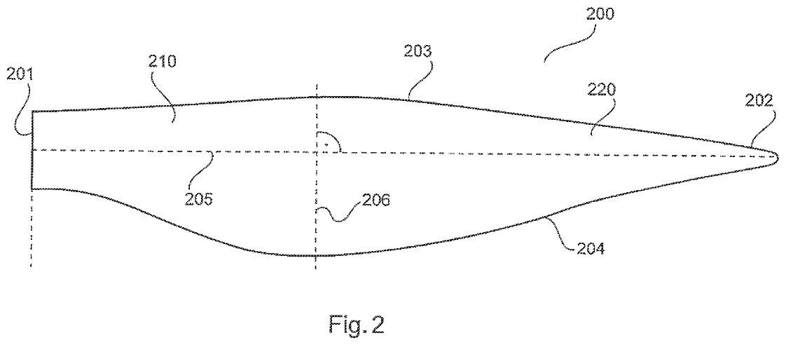

FIG. 2 shows a schematic illustration of a wind power plant rotor blade according to a first exemplary embodiment. The rotor blade 200 has a rotor blade root 201, a rotor blade tip 202, a rotor blade leading edge 203 and a rotor blade trailing edge 204. The rotor blade 200 further has a rotor blade longitudinal axis 205 as well as a dividing plane 206, for example which is configured at a right angle to the rotor blade longitudinal axis 205 and parallel to the rotor blade root 201a. If the rotor blade is split along the dividing line 206, the rotor blade has a rotor blade inner section 210 and a rotor blade outer section 220.

The rotor blade can further have two half shells, which can be bonded together. In the first exemplary embodiment, the two half shells are first manufactured, and then bonded together. If a one-part rotor blade is required, the rotor blade is not split along the dividing plane 206. However, if a multi-part rotor blade is required, the rotor blade is split along the dividing plane 206. For example, this can be done by sawing open the rotor blade at this location. In particular, this only takes place if the two half shells have been manufactured and bonded together. The rotor blade according to the first exemplary embodiment can thus have a one-part or multi-part configuration, without having to adjust the molds necessary for manufacturing the half shells for this purpose. Therefore, the rotor blade according to the first exemplary embodiment is suitable for use as a one-part or multi-part rotor blade.

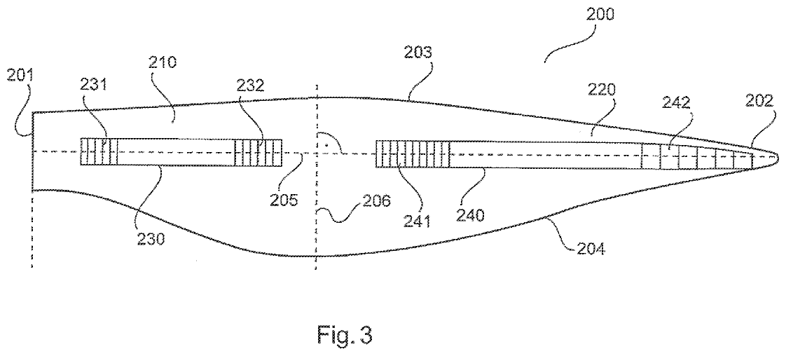

FIG. 3 shows a schematic illustration of a wind power plant rotor blade according to a second exemplary embodiment. In addition to the parts of the rotor blade shown on FIG. 2, the rotor blade according to FIG. 3 has a first main belt 230 in the rotor blade inner section 210 and a second main belt 240 in the rotor blade outer section 220. The two main belts 230, 240 are used to absorb and divert the forces acting on the rotor blade. The respective ends 231, 232; 241, 242 of the first and second main belts 230, 240 can be scarfed in design.

The dividing plane 206 is preferably provided in the area of the inner third, i.e., the dividing plane 206 is located within the first 33% of the length of the rotor blade, so as to ideally be able to clamp and service the connecting elements from inside.

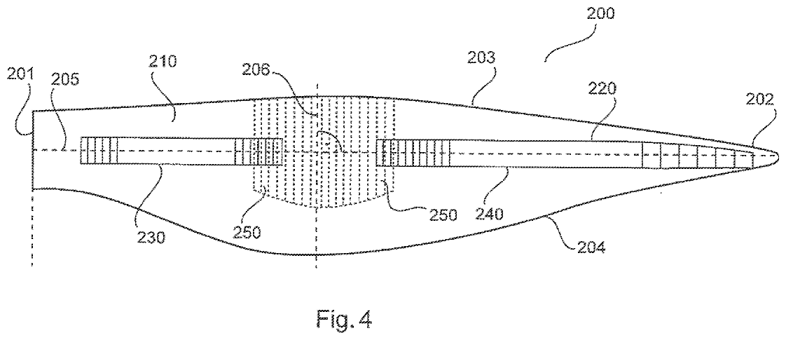

FIG. 4 shows a schematic illustration of a wind power plant rotor blade according to a third exemplary embodiment. In addition to the elements shown on FIG. 3, the rotor blade has a reinforcement area 250 both in and on the rotor blade inner section 210, as well as on the rotor blade outer section 220. The reinforcement area 250 can optionally be scarfed in design, and is intended to enable a connection between the rotor blade inner section 210 and the rotor blade outer section 220 once the rotor blade has been split along the dividing plane 206, so as to obtain a multi-part rotor blade. An increase in the inertia moment is limited by additional dead weight.

In particular by providing the reinforcement area 250 on the rotor blade inner section 210 and the rotor blade outer section, and in particular in the area of the dividing plane 206, the rotor blade can be used as one part or multiple parts. For multi-part use, the rotor blade need only be split or sawn open along the dividing plane 206 (which preferably is configured perpendicular to the rotor blade longitudinal axis 205). The rotor blade need not be further adjusted for the multi-part mold.

As a consequence, the same molds can be used for manufacturing the half shells, regardless of whether the rotor blade is to have a one-part or multi-part configuration.

While providing the reinforcement area 250 does increase the weight of the rotor blade (for example by approx. 10%), the molds required for manufacturing the half shells remain the same, regardless of whether a one-part or multi-part rotor blade is required.

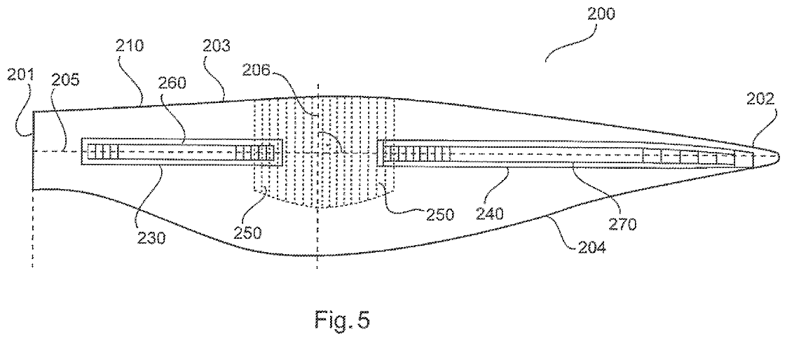

FIG. 5 shows a schematic illustration of a wind power plant rotor blade according to a fourth exemplary embodiment. In addition to the elements shown on FIG. 4, the rotor blade 200 according to the fourth exemplary embodiment has main webs 260, 270 in the area of the belts 230, 240. The main webs 260, 270 preferably end in the area of the reinforcement area 250 before the dividing plane 206. As a consequence, the main webs 260, 270 do not have a continuous configuration. Therefore, neither main webs nor main belts are provided in particular around the area of the dividing plane 206.

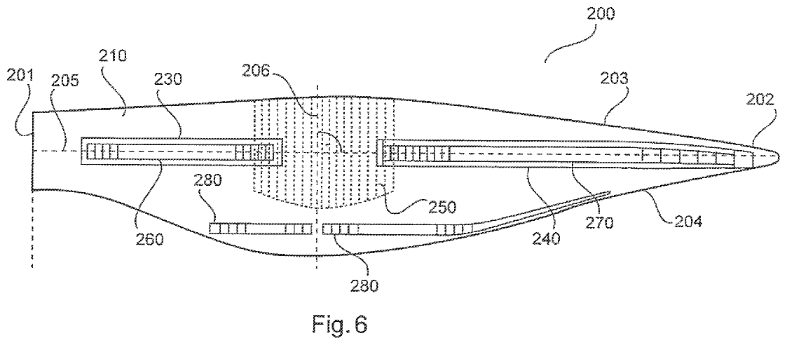

FIG. 6 shows a schematic illustration of a wind power plant rotor blade according to a fifth exemplary embodiment. In addition to the elements of the rotor blade according to the fourth exemplary embodiment, the rotor blade 200 according to the fifth exemplary embodiment has a trailing edge reinforcement 280 (e.g., in the form of belts) and a trailing edge web 290 (not shown on FIG. 6) both in the rotor blade inner section 210 and in the rotor blade outer section 220. As a consequence, the trailing edge reinforcement or the trailing edge webs do not have a continuous configuration, but rather are split in the area of the dividing plane 206. A connection can optionally be provided between the trailing edge webs on the rotor blade inner section 210 and the rotor blade outer section 220.

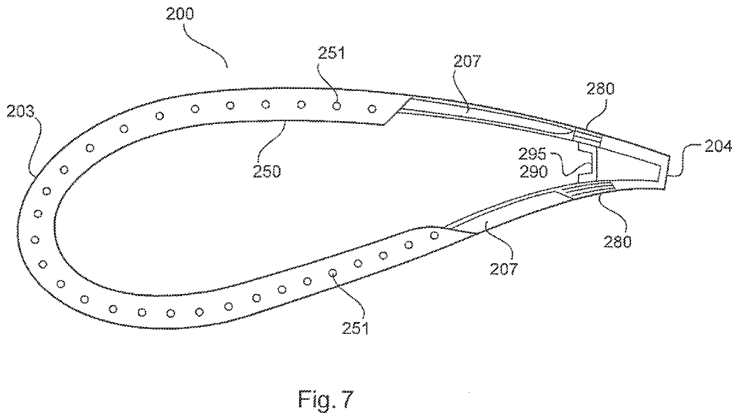

FIG. 7 shows a schematic illustration of a wind power plant rotor blade according to a sixth exemplary embodiment. The rotor blade 200 according to the sixth exemplary embodiment has a leading edge 203 and a trailing edge 204. In addition, the rotor blade 200 has a rotor blade wall 207, for example which can be manufactured with a sandwich design. The trailing edge reinforcements 280 can be provided in the rotor blade wall 207. Further provided is a reinforcement area 250 with a plurality of holes or through bores 251, which can enable a connection with the other rotor blade part. Further provided are a trailing edge web 290 and an extra web 295 (the perspective view on FIG. 7 shows the web 290 and the web 295 superposed), which serves as a connecting element to allow a transfer of forces.

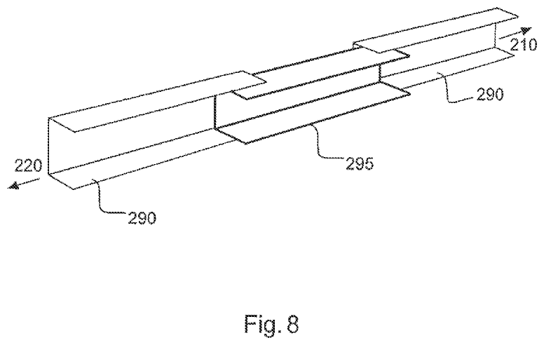

FIG. 8 shows a perspective view of trailing edge webs according to the seventh exemplary embodiment. In particular, FIG. 8 provides the two trailing edge webs 290, which each are provided on the rotor blade inner section 210 and the rotor blade outer section 220. Provided between the two trailing edge webs 290 is an extra web 295, which serves to establish a connection between the two trailing edge webs 290 on the rotor blade inner section and the rotor blade outer section. An overlap is preferably provided between the trailing edge webs 290 and the extra web 295. For example, this overlap can measure between 100 and 300 mm.

The extra web 295 then serves as a connecting element, so that forces between the trailing edge webs 290 can be diverted.

The trailing edge webs 290 can be provided in the area of the trailing edge reinforcement 280. As shown on FIG. 7, for example, the webs 290 can be provided as a connection between the trailing edge reinforcements 280 on the suction side and pressure side.

1. A wind power plant rotor blade, comprising:
a rotor blade root area, a rotor blade tip area, a rotor blade leading edge, a rotor blade trailing edge, a rotor blade longitudinal axis, a rotor blade inner section, a rotor blade outer section, and a dividing plane between the rotor blade outer section and the rotor blade inner section, wherein the rotor blade is configured to be split along the dividing plane; and
respective reinforcement areas in the rotor blade inner section and the rotor blade outer section and arranged at the dividing plane,
wherein the dividing plane and the reinforcement areas are adapted such that the rotor blade is of a multi-part design configured to be split at the dividing plane,
wherein, after splitting the rotor blade along the dividing plane, the reinforcement area on the rotor blade inner section is configured to be fastened to the reinforcement area of the rotor blade outer section.

2. The wind power plant rotor blade according to claim 1, further comprising:
a first main belt in the rotor blade inner section and a second main belt in the rotor blade outer section.

3. The wind power plant rotor blade according to claim 2, wherein ends of the first and second main belts are scarfed.

4. The wind power plant rotor blade according to claim 1, further comprising:
a first web in the area of the first main belt and a second web in the area of the second main belt,
wherein the first and second webs end before the dividing plane.

5. The wind power plant rotor blade according to claim 1, further comprising:
a trailing edge reinforcement and a trailing edge web in the rotor blade inner section and in the rotor blade outer section.

6. The wind power plant rotor blade according to claim 1, wherein the reinforcement areas have a plurality of through holes.

7. A wind power plant comprising an aerodynamic rotor and at least one wind power plant rotor blade according to claim 1 coupled to the aerodynamic rotor.

8. A method for mounting a wind power plant rotor blade to a nacelle of a wind power plant, the method comprising:
checking logistical restrictions on an installation site of the wind power plant,
selecting a one-part or multi-part rotor blade based on the logistical restrictions,
manufacturing a wind power plant rotor blade in a one-part version in a main die based on the logistical restrictions,
splitting the wind power plant rotor blade manufactured in one part along at least one dividing plane based on the logistical restrictions to obtain at least one rotor blade inner section and at least one rotor blade outer section,
transporting the rotor blade inner section and the rotor blade outer section to the installation site separately from each other;
joining the rotor blade inner section and the rotor blade outer section together at the installation site, and
mounting the assembled rotor blade on the nacelle of the wind power plant.
